(19) United States
(12) Patent Application Publication
(10) Pub. No.: US 2017/0275405 A1
(43) Pub. Date: Sep. 28, 2017

(54) MELT SPINNABLE COPOLYMERS FROM POLYACRYLONITRILE, METHOD FOR PRODUCING FIBERS OR FIBER PRECURSORS BY MEANS OF MELT SPINNING, AND FIBERS PRODUCED ACCORDINGLY

(71) Applicant: FRAUNHOFER-GESELLSCHAFT ZUR FÖRDERUNG DER ANGEWANDTEN FORSCHUNG E.V., München (DE)

(72) Inventors: Mathias HAHN, Michendorf (DE); Antje LIESKE, Potsdam (DE); Mats KNOOP, Potsdam (DE)

(73) Assignee: FRAUNHOFER-GESELLSCHAFT ZUR FÖRDERUNG DER ANGEWAND TEN FORSCHUNG E.V., München (DE)

(21) Appl. No.: 15/514,421

(22) PCT Filed: Sep. 10, 2015
(86) PCT No.: PCT/EP2015/070769

§ 371 Date: Mar. 24, 2017

(30) Foreign Application Priority Data
Sep. 29, 2014 (DE) 10 2014 219 707.4

(51) Int. Cl. C08F 220/44; D01F 6/38; D01F 9/22; D01D 5/08

(52) U.S. Cl. CPC C08F 220/44; D01D 5/08; D01F 6/38; D01F 9/225

(57) ABSTRACT

The invention relates to melt spinnable copolymers of polyacrylonitrile (PAN) which are producible by means of copolymerisation of acrylonitrile with an alkoxyalkylacrylate. As additional comonomers alkylacrylates and vinyl esters may be considered. Likewise, the invention relates to a method for the production of fibres or fibre precursors, in particular carbon fibre precursors, by means of melt spinning, in which the mentioned copolymer is used. Furthermore, the invention relates to fibres produced in this way, in particular carbon fibres.

The invention relates to melt spinnable copolymers of polyacrylonitrile (PAN) which are producible by means of copolymerisation of acrylonitrile with an alkoxyalkylacrylate. As additional comonomers alkylacrylates and vinyl esters may be considered. Likewise, the invention relates to a method for the production of fibres or fibre precursors, in particular carbon fibre precursors, by means of melt spinning, in which the mentioned copolymer is used. Furthermore, the invention relates to fibres produced in this way, in particular carbon fibres.

Carbon fibres which are gaining ever greater importance in the field of technical fibres are produced, according to the state of the art, by thermal conversion of separately produced precursor fibres. Materials for the precursor fibres are above all PAN (co)polymers (acrylic precursors) and also pitch. Acrylic precursor fibres have been produced commercially to date exclusively via wet- or dry-spinning methods. For this purpose, a solution of polymers with concentrations ≦20% is either spun in a coagulation bath or a hot steam atmosphere, the solvent diffusing out of the fibre. In this way, qualitatively high-value precursors are produced, however, the costs of the methods are comparatively high. This results from the required solvents and handling thereof on the one hand side and from the relatively low throughput in solution spinning methods on the other hand side.

Because of the strong inter- and intramolecular interactions of the nitrile groups, the melting point of PAN at 320° C. is above the decomposition temperature of the polymer. This means that melt spinning of pure PAN is not possible, the polymer does not behave as a thermoplast but rather as a duroplast. At the same time, the possibility for the production of precursor fibres by means of melt spinning would however imply a significant cost saving in the precursor production since the throughput during melt spinning is substantially higher and in addition no solvents are needed which cause costs for obtaining and recycling/disposal.

Efforts have been made for several decades to make PAN amenable to processing by means of melt spinning. In principle, approaches by way of an external softening (mixing of the polymer with additives) and internal softening (copolymerisation) must therefore be differentiated. In both cases, the interaction of the nitrile groups is thereby disturbed so that the melting is effected below the decomposition temperature of the polymer.

An essential prerequisite of further processing to form carbon fibres is the possibility of stabilising the fibres subsequently oxidatively. This process is implemented at temperatures above 200° C. and results in the formation of cyclic structures which only enable the subsequent carbonisation. Of course this can only succeed when the fibres do not melt at the stabilisation temperatures—which represents an additional problem to be solved since the stabilisation temperatures are in general higher than the processing temperatures during melt spinning.

Internal softening is achieved by copolymerisation with suitable comonomers. Already in 1970, the production of thermoplastic acrylonitrile copolymers for fibre production by means of melt spinning at 200 to 240° C. was described in GB1270504. Textile fibres are referred to as field of application. Thereby 8-50% by weight of aliphatic/alicyclic alkenes and/or acrylates are used as comonomers, methyl-, ethyl-, butylacrylate, isobutene, vinyl acetate and propene being listed in the application examples. In addition, the copolymers comprise 0.2-10% by weight of sulphonic acid group-containing monomers. Such acid group-containing copolymers are however not suitable for a continuous melt spinning method since the melt viscosity is not stable but rather increases inevitably in the course of time because of the cyclisation reaction of the nitrile groups, catalysed by the acid groups.

In U.S. Pat. No. 3,499,073, the production of thermoplastic PAN copolymers with the help of an organometal catalyst is described. The polymers—also homopolymers of PAN—could be processed to form monofilaments at temperatures from 250° C. to 295° C.

GB1294044 describes acrylonitrile copolymers which comprise 60-70% acrylonitrile, 25-30% methacrylonitrile and 5-10% acrylates or methacrylates and have softening points between 125° C. and 175° C. At the described softening point, the polymer is not however present as a melt but as a film which is rendered flexible.

In U.S. Pat. No. 4,107,252, copolymers of acrylonitrile with 12-18% by weight of styrene and 13-18% of isobutene, which have melt temperatures between 175° C. and 260° C., are presented. The comonomer contents are, however, much too high to be able to produce carbon fibres from such copolymers. In general, it is assumed that a PAN copolymer suitable for carbon fibres must comprise an average chain length of ≧9 of successive acrylonitrile units. Realistically, only approx. 10% by mol comonomer content can therefore be tolerated.

In EP0030666, thermoplastic acrylonitrile copolymers with up to 96% acylonitrile content for hoses and films are described, which are produced by grafting of acrylonitrile onto an elastomer phase. Such polymers have branched structures because of the grafting and are not suitable for fibre production.

GB 2356830 describes thermoplastic formation of acrylonitrile polymers with 96 - 100% acrylonitrile content by means of a special pressure- and temperature regime, however the author excludes the possibility for use for melt spinning because of the necessary high extruder pressures.

U.S. Pat. No. 5,618,901 describes a process for the production of a thermoplastic acrylonitrile copolymer, consisting of 50-95% acrylonitrile and 5-50% of a comonomer, there being covered firstly all conceivable comonomer classes (acrylates, methacrylates, acrylamides, methacrylamides, acrylamide derivatives, methacrylamide derivatives, vinyl esters, vinyl ethers, vinyl amides, vinyl ketones, styrene, halogen-containing monomers, ionic monomers, acid group-containing monomers, amino group-containing monomers, olefins and combinations). The embodiments indicate methyl styrene, styrene, vinyl acetate, methylacrylate and methylmethacrylate with at least 15% by weight of proportion (corresponds to approx. 10% by mol for methylacrylate) of copolymer. The copolymers could be extruded at 200° C.

U.S. Pat. No. 6,114,034 describes the production of fibres from precisely these copolymers, wherein in the embodiments exclusively methylacrylate and vinyl acetate are being used as comonomers, and in fact in a proportion of 15-25% by weight. Fibres could be produced with diameters of 3-8 dtex and strengths up to 29 cN/tex (15% methylacrylate) or 55 cN/tex (25% methylacrylate), the spinning temperatures, as a function of the molar mass, were between 210° C. (55,000 g/mol) and 240° C. (90,000 g/mol). However, some works show that such copolymers have no stable melt viscosity. A copolymer with 10% by mol of MA and a molar mass of 126,000 g/mol showed, after 20 min at 200° C., an increase in complex viscosity by 35%, a copolymer with 20% by mol of methylacrylate and a molar mass of 68,000 g/mol still one of 10%. If the complex viscosity is followed via the temperature, then for the above-mentioned copolymer with 10% by mol of methylacrylate, a decrease in complex viscosity with a temperature up to a temperature of 220° C. is found, at higher temperatures the temperature increases again because of the start of decomposition- and stabilisation processes. Such instability is not compatible with a technical melt spinning process. It leads to cracks at hot spots in the spinning extruder, in the spinning pump and in the spinning nozzle and to defects in the spun fibre. A melt spinnable PAN precursor should have at most 11% by mol of comonomer, be processible at temperatures of max. 220° C. and simultaneously have a stable melt viscosity up to at least 240° C. in order to be able to tolerate temperature peaks due to mechanical stresses in the spinning extruder and spinning pump.

In WO 00/50675, the use of the above-described copolymers for the production of carbon fibre precursors is patented. With respect to content, the patent does, however, not extend beyond U.S. Pat. No. 6,114,034. Methylacrylate, ethylacrylate, methylmethacrylate and vinyl acetate are indicated as preferred comonomers.

Starting herefrom, it was the object of the present invention to provide precursors based on polyacrylonitrile which display an improved suitability for melt spinning processes.

This object is achieved by the copolymer having the features of claim 1 and the method for the production of fibres by means of melt spinning having the features of claim 11 and also by the fibre having the features of claim 15. The further dependent claims reveal advantageous developments.

According to the invention, a melt spinnable copolymer of polyacrylonitrile (PAN) is provided, which is producible by copolymerisation of 95 to 80% by mol of acrylonitrile with at least one comonomer, selected from
a) 5 to 20% by mol of at least one alkoxyalkylacrylate of general formula I

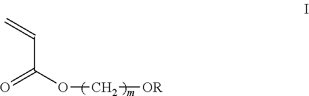

with
R=CₙH₂ₙ₊₁ and n=1-8 and m=1-8, in particular n=1-4 and m=1-4
b) 0 to 10% by mol of at least one alkylacrylate of general formula II

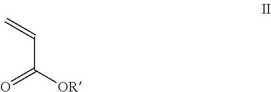

with
R=CₙH₂ₙ₊₁ and n=1-18,
c) 0 to 10% by mol of at least one vinyl ester of general formula III

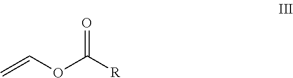

with
R=CₙH₂ₙ₊₁ and n=1-18.

The copolymer thereby has a weight-average molar mass (Mw) in the range of 10,000 to 150,000 g/mol.

The copolymer is spinnable preferably in the temperature range from 160 to 240° C., in particular from 180 to 220° C.

The copolymer according to the invention preferably has a melt viscosity which is constant or decreasing with increasing temperature up to 240° C., in particular up to 260° C. This proves that the copolymer according to the invention has particularly high stability of the melt viscosity.

The copolymerisation is preferably carried out by precipitation polymerisation, emulsion polymerisation and/or polymerisation in a solvent. The solvent is thereby selected preferably from the group consisting of dimethylsulphoxide, dimethylformamide, dimethylacetamide, N-methylpyrrolidone, ethylene carbonate, propylene carbonate, aqueous sodium rhodanide solution and mixtures hereof.

The proportion of the at least one alkoxyalkylacrylate is preferably 8 to 12% by mol.

A further preferred embodiment provides that a mixture of comonomers of at least one alkoxyalkylacrylate and of at least one alkylacrylate is present. The proportion of the at least one alkylacrylate can thereby be preferably in the range of 1 to 5% by mol.

A further preferred embodiment provides that a mixture of at least one alkoxyalkylacrylate and at least one vinyl ester is present. The proportion of the at least one vinyl ester is thereby preferably in the range of 1 to 5% by mol. It is further preferred that the copolymer has a weight-average molar mass (Mw) in the range from 15,000 to 80,000 g/mol.

Likewise, it is also possible that alkoxyalkylacrylates in conjunction with alkylacrylates and vinyl esters are used as comonomers.

According to the invention, a method for the production of fibres or fibre precursors by means of melt spinning is likewise provided, in which
i. a copolymerisation of 95 to 80% by mol of acrylonitrile with at least one comonomer selected from
   a) 5 to 20% by mol of at least one alkoxyalkylacrylate of general formula I

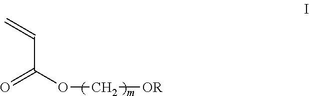

with
R=CₙH₂ₙ₊₁ and n=1-8 and m=1-8, in particular n=1-4 and m=1-4
b) 0 to 10% by mol of at least one alkylacrylate of general formula II

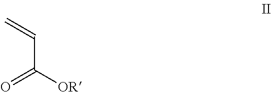

with
R=CₙH₂ₙ₊₁ and n=1-18,
c) 0 to 10% by mol of at least one vinyl ester of general formula III

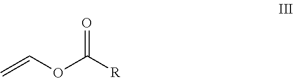

with
R=CₙH₂ₙ₊₁ and n=1-18,
is carried out in the presence of at least one initiator,
ii. the copolymer is spun with an extruder with at least one nozzle, suitable for spinning, at the extruder outlet, to form mono- or multifilaments.

It is thereby possible that, directly before or during extrusion in b), at least one softening agent is added, which is selected in particular from the group consisting of water, nitroalkanes, alkylalcohols, ionic liquids, glycols, dimethylsulphoxide, dimethylformamide, dimethylacetamide, N-methylpyrrolidone, ethylene carbonate, propylene carbonate, aqueous sodium rhodanide solution and mixtures hereof. If a softener is added, a pressure chamber can be connected after the spinning nozzle in order to prevent explosion-like evaporation of softeners boiling below processing temperatures.

In the case where the fibres concern carbon fibres, the two following successive steps are preferably implemented:
i. stabilisation of the filaments by a temperature treatment at temperatures from 200 to 350° C. and
ii. carbonisation of the filaments at temperatures from 800 to 1,200° C.

Stabilisation of the filaments is effected preferably at temperatures from 180 to 320° C., preferably from 180 to 300° C., particularly preferably from 180 to 250° C.

It is further preferred that, during the copolymerisation in step (i.), the initiator of the radical polymerisation is selected from the group consisting of azo compounds, peroxides, hydroperoxides, alkylperoxides, peroxodicarbonates, peroxyesters, dialkylperoxides, persulphates, perphosphates, redox initiators and mixtures hereof.

According to the invention, likewise fibres, in particular carbon fibres, which are producible according to the previously described method are provided.

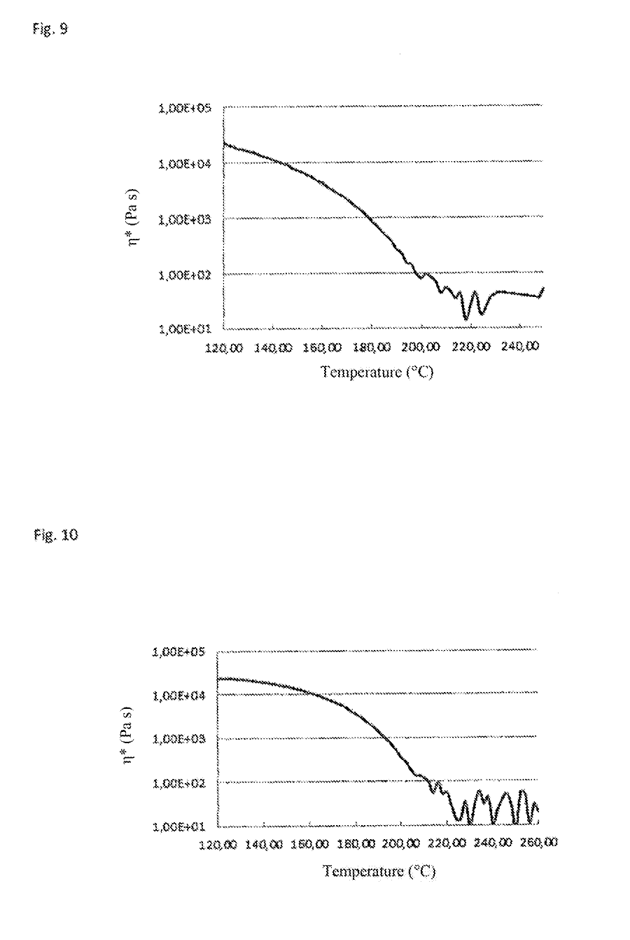

The subject according to the invention is intended to be explained more with reference to the subsequent examples and Figures without wishing to restrict said subject to the special embodiments shown here. FIGS. 1 to 11 show, with reference to diagrams, the temperature dependency of the viscosity for the examples subsequently listed.

### EXAMPLES

In the examples, the following devices were used:

Mini-Haake: this concerns a mini-2-screw extruder “HAAKE Minilab”, Thermo Electron Corporation, Germany. At the melt outlet opening, a 1-hole-nozzle with a hole diameter of 500 μm was fitted. The metering was effected by hand. The emerging monofilament was drawn-off with a winding head (max. 400 m/min) and wound onto a bobbin.

Test unit Multi-Filament-Spinning (Spinning tester): the construction includes a 2-screw extruder (L/D=30) with 4 temperature zones. The metering was effected gravimetrically under nitrogen atmosphere, the feed was temperature-controlled to max. 40° C. At the end of the extruder, the spinning packet with melt filter (100 μm) and also nozzle plate (42-hole nozzle, hole diameter 400 μm, L/D=4) was mounted. A galette duo which could draw-off at a speed of up to 100 m/min served as draw-off element. The final winding of the filament yarn was produced by a cross-wound cone winder.

### Comparative Example 1

Precipitation polymerisation to form copolymer with 10% by mol of methylacrylate and spinning on Mini-Haake.

In a jacketed reactor with reflux cooling and anchor agitator, 340 g water, 0.39 g ascorbic acid and 0.2 g mercaptoethanol were introduced under nitrogen purging. A mixture of 6.1 g methylacrylate and 33.9 g acrylonitrile is added. This is heated to 30° C. internal reactor temperature, 200 μl of a 1% solution of iron(II)sulphate heptahydrate is added and subsequently a solution of 0.45 ammonium persulphate in 10 g water is added. After 1.5 h, the reaction is terminated, the reactor contents are filtered, washed with water and ethanol and dried in a vacuum.

The resulting polymer has a relative viscosity of 2.0. The composition corresponded, with 9.7% by mol of methylacrylate and 90.3% by mol of acrylonitrile, almost to the feed values.

The rheological measurement in oscillation mode (temperature sweep) is illustrated in FIG. 1.

An increase in the complex viscosity at temperatures above 220° C. can be noted.

The polymer was spun to form a monofilament in the Mini-Haake at 230° C. with a maximum draw-off speed of 40 m/min. Higher draw-off speeds could not be achieved. A spinning process which was stable over a fairly long time was not possible.

### Comparative Example 2

Solution polymerisation to form copolymer with 10% by mol of methylacrylate and spinning on Mini-Haake

In a 250 ml round flask with reflux cooler and nitrogen inflow, 72 g N-methylpyrrolidone are introduced under magnetic agitation. A mixture of 7.4 g methylacrylate and 40.6 g acrylonitrile are added and heated with an oil bath to 60° C. A solution of 180 mg V-65 (2,2′azobis(2,4-dimethylvaleronitrile), Co. Wako) in 2 ml acetone is added after reaching the temperature. The reaction time is 6 h. The reaction mixture is precipitated in 500 ml ethanol, the polymer is filtered off, washed with ethanol and dried in a vacuum.

The resulting polymer has a relative viscosity of 1.5. The molar mass Mw was determined at 29,000 g/mol with a PDI of 1.5. The composition corresponded, with 9.3% by mol of methylacrylate and 90.7% by mol of acrylonitrile, almost to the feed values.

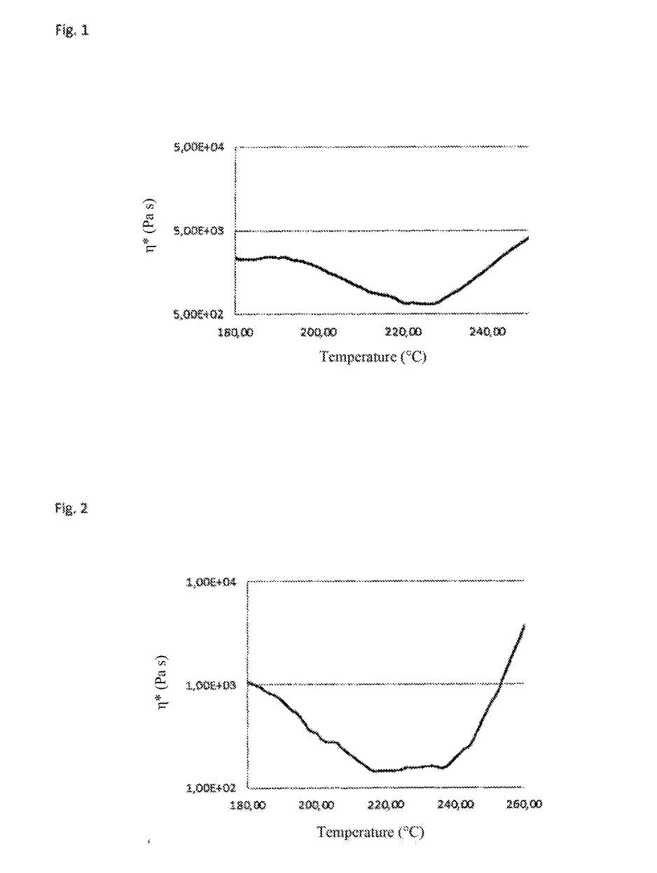

The rheological measurement in oscillation mode (temperature sweep) is illustrated in FIG. 2.

An increase in the complex viscosity at temperatures above 230° C. can be noted.

The polymer was spun to form a monofilament in the Mini-Haake at 220° C. with a maximum draw-off speed of 200 m/min. A spinning process which is stable over a fairly long time was not possible.

### Example 1

Precipitation polymerisation to form copolymer with 10% methoxyethylacrylate (m=2; n=1) and spinning on Mini-Haake

In a jacketed reactor with reflux cooling and anchor agitator, 340 g water, 0.39 g ascorbic acid and 1.0 g mercaptoethanol are introduced under nitrogen purging. A mixture of 8.6 g methoxyethylacrylate and 31.4 g acrylonitrile is added. It is heated to 30° C. internal reactor temperature, 200 μl of a 1% solution of iron(II)sulphate heptahydrate is added and subsequently a solution of 0.45 g ammonium persulphate in 10 g water is added. After 1.5 h, the reaction is terminated, the reactor contents are filtered, washed with water and ethanol and dried in a vacuum.

The resulting polymer has a relative viscosity of 1.4. The molar mass Mw was determined at 22,000 g/mol with a PDI of 2.3. The composition corresponded, with 10.2% by mol of methoxyethylacrylate and 89.8% by mol of acrylonitrile, almost to the feed values.

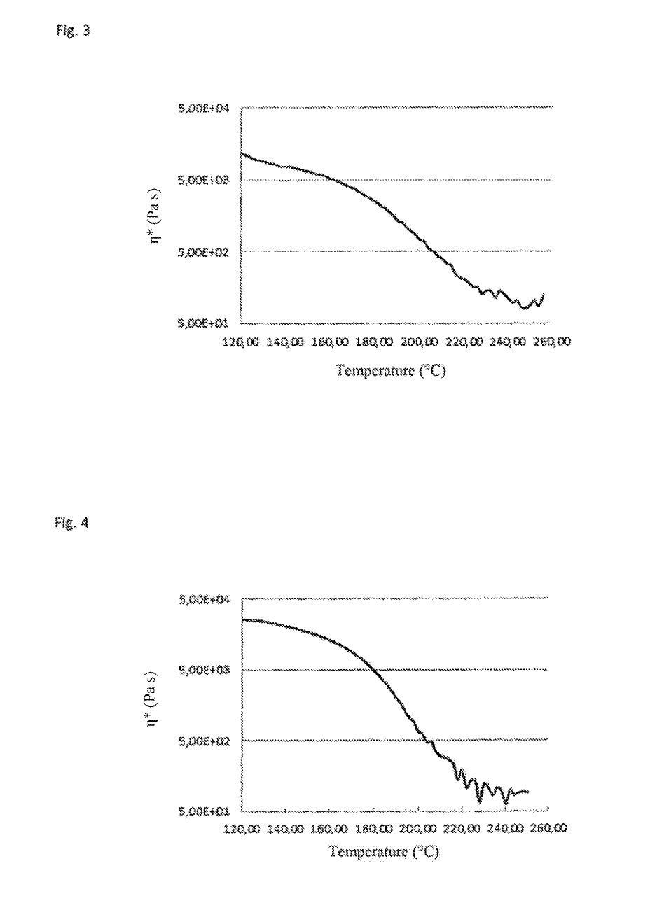

The rheological measurement in oscillation mode (temperature sweep) is illustrated in FIG. 3.

No increase again in the complex viscosity up to temperatures of at least 255° C. can be noted.

The polymer was spun to form a monofilament in the Mini-Haake at 180° C. with a maximum draw-off speed of 200 m/min. The titre of the fibre was 2.8 tex, the strength 16.4 cN/tex, the breaking elongation 16.4%.

### Example 2

Solution polymerisation to form copolymer with 10% methoxyethylacrylate and spinning on Mini-Haake

In a 250 ml round flask with reflux cooler and nitrogen inflow, 80 g dimethylsulphoxide was introduced under magnetic agitation. A mixture of 4.3 g methoxyethylacrylate, 15.7 g acrylonitrile and 500 mg mercaptoethanol is added and heated with an oil bath to 60° C. A solution of 250 mg V-65 (2,2′azobis (2,4-dimethylvaleronitrile), Co. Wako) in 1 mol acetone is added after reaching the temperature. The reaction time is 6 h. The reaction mixture is precipitated in 500 ml ethanol, the polymer is filtered off, washed with ethanol and dried in a vacuum.

The resulting polymer has a relative viscosity of 1.4. The composition corresponded, with 9.7% mol of methoxyethylacrylate and 90.3% by mol of acrylonitrile, almost to the feed values.

The polymer was spun to form a monofilament in the Mini-Haake at 180° C. with a maximum draw-off speed of 400 m/min. The titre of the fibre was 1.0 tex, the strength 11.5 cN/tex, the breaking elongation 19.0%.

### Example 3

Solution polymerisation to form copolymer with 10% methoxyethylacrylate and spinning on Mini-Haake

In a 100 ml round flask with reflux cooler and nitrogen inflow, 36 g N-methyl-2-pyrrolidone (NMP) are introduced under magnetic agitation. A mixture of 5.15 g methoxyethylacrylate, 18.85 g acrylonitrile is added and heated with an oil bath to 60° C. A solution of 98 mg V-65 (2,2′azobis(2,4-dimethylvaleronitrile), Co. Wako) in 0.5 ml acetone is added after reaching the temperature. The reaction time is 6 h. The reaction mixture is precipitated in 500 ml water, the polymer filtered off, washed with ethanol and dried in a vacuum.

The resulting polymer has a relative viscosity of 1.6. The molar mass Mw was determined at 44,000 g/mol with a PDI of 1.4. The composition corresponded, with 9.6% by mol of methoxyethylacrylate and 90.4% by mol of acrylonitrile, almost to the feed values.

The rheological measurement in oscillation mode (temperature sweep) is illustrated in FIG. 4.

No increase again in the complex viscosity up to temperatures of at least 250° C. can be noted.

The polymer was spun to form a monofilament in the Mini-Haake at 180° C. with a maximum draw-off speed of 118 m/min. The titre of the fibre was 4.3 tex, the strength 18.3 cN/tex, the breaking elongation 16.5%.

### Example 4

Solution polymerisation to form copolymer with 10% butoxyethylacrylate (m=2, n=4) and spinning on Mini-Haake

In a 100 ml round flask with reflux cooler and nitrogen inflow, 36 g N-methyl-2-pyrrolidone (NMP) are introduced under magnetic agitation. A mixture of 6.4 g butoxyethylacrylate and 17.6 g acrylonitrile is added and heated with an oil bath to 60° C. A solution of 92 mg V-65 (2,2′azobis(2,4-dimethylvaleronitrile), Co. Wako) in 0.5 ml acetone is added after reaching the temperature. The reaction time is 6 h. The reaction mixture is precipitated in 500 ml water, the polymer is filtered off, washed with ethanol and dried in a vacuum.

The resulting polymer has a relative viscosity of 1.6. The composition corresponded, with 9.7% by mol of butoxyethylacrylate and 90.3% by mol of acrylonitrile, almost to the feed values.

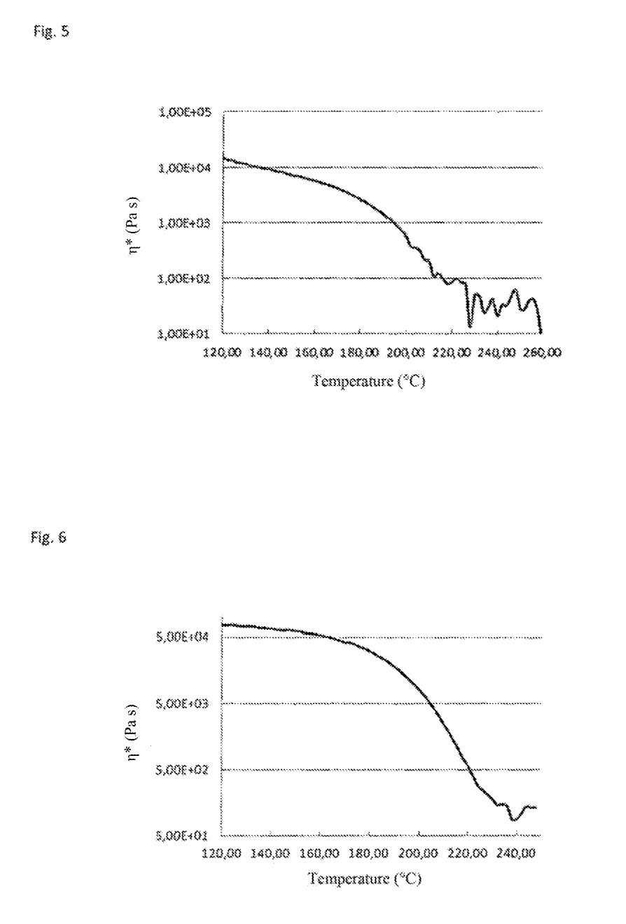

The rheological measurement in oscillation mode (temperature sweep) is illustrated in FIG. 5.

No increase again in the complex viscosity up to temperatures of at least 250° C. can be noted.

The polymer was spun to form a monofilament in the Mini-Haake at 200° C. with a maximum draw-off speed of 98 m/min. The titre of the fibre was 8 tex, the strength 9.5 cN/tex, the breaking elongation 14.2%.

### Example 5

Solution polymerisation to form copolymer with 7.5% methoxyethylacrylate and spinning on Mini-Haake

In a 1.8 1 stainless steel reactor, 222.0 g N-methyl-2-pyrrolidone (NMP), 123.4 g acrylonitrile and 24.6 g 2-methoxyethylacrylate are introduced and made inert with nitrogen by means of an inflow pipe for 15 min. The closed reactor is thereupon heated to 55° C. and a solution of 615 mg V-40 (1,1′-azobis(cyclohexanecarbonitrile), Co. Wako) in 8 ml NMP is injected by means of a syringe via an inlet. The reaction mixture is then agitated for 6 h at 90° C.

The mixture is received in 2 1 NMP after the reaction and precipitated in 5 times the quantity of water. After filtration of the polymer, this is washed with water and ethanol and dried at 60° C. in a vacuum.

The resulting polymer has a relative viscosity of 1.4. The molar mass Mw was determined at 38,000 g/mol with a PDI of 1.2. The composition corresponded, with 7.1% by mol of methylacrylate and 92.9% by mol of acrylonitrile, almost to the feed values.

The rheological measurement in oscillation mode (temperature sweep) is illustrated in FIG. 6.

No increase again in the complex viscosity up to temperatures of at least 250° C. can be noted.

The polymer was spun to form a monofilament in the Mini-Haake at 200° C. with a maximum draw-off speed of 98 m/min. The titre of the fibre was 7.3 tex, the strength 7.7 cN/tex, the breaking elongation 16.8%.

### Example 6

Solution polymerisation to form copolymer with 10% methoxyethylacrylate and spinning on spinning tester

In a 7.5 1 stainless steel reactor, 3,000 g N-methyl-2-pyrrolidone (NMP), 1,630 g acrylonitrile and 449 g 2-methoxyethylacrylate are introduced and made inert with nitrogen by means of an inflow pipe for 15 min. The closed reactor is thereupon heated to 55° C. and a solution of 8.8 g V-40 (1,1′-azobis(cyclohexanecarbonitrile), Co. Wako) in 100 ml NMP is injected by means of a syringe via an inlet. The reaction mixture is then agitated for 6 h at 90° C.

The mixture is precipitated in 5 times the quantity of water after the reaction. After filtration of the polymer, this is washed with water and ethanol and dried at 60° C. in a vacuum.

The resulting polymer has a relative viscosity of 1.3. The composition corresponded, with 9.7% by mol of methylacrylate and 90.3% by mol of acrylonitrile, almost to the feed values.

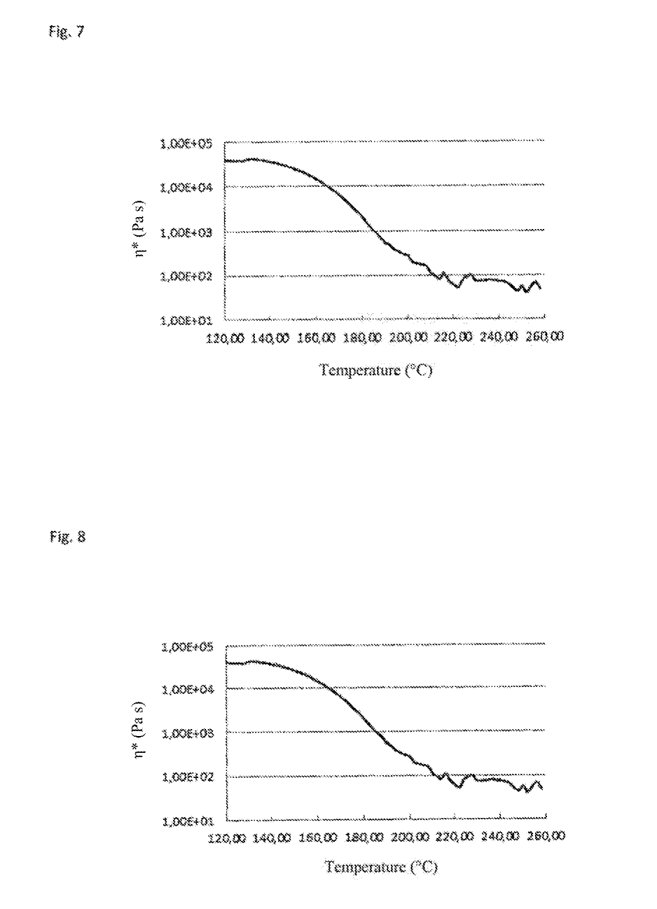

The rheological measurement in oscillation mode (temperature sweep) is illustrated in FIG. 7.

No increase again in the complex viscosity up to temperatures of at least 250° C. can be noted.

The polymer was spun in the spinning tester under the following conditions: temperature zones in the extruder 110° C./ 160° C./ 180° C./ 180° C.; spinning nozzle temperature 180° C.; maximum draw-off speed of 100 m/min. The titre of the individual fibre was 0.82 tex, the strength 16.3 cN/tex, the breaking elongation 17.6%.

At a draw-off speed of 40 m/min, an individual fibre titre of 2.1 tex was obtained, the strength was 10.1 cN/tex, the breaking elongation 53.6%. This fibre was stretched again in 80° C. hot water. The thereby obtained individual fibre titre was 0.80 tex, the strength 22.4 cN/tex, the breaking elongation 19.0%.

### Example 7

Solution polymerisation to form copolymer with 10% methoxyethylacrylate and spinning on spinning tester

In a 1.8 1 steel reactor, 499.5 g N-methyl-2-pyrrolidone (NMP), 166.5 g DMSO, 348.8 g acrylonitrile and 95.1 g 2-methoxyethylacrylate are introduced and made inert with nitrogen by means of an inflow pipe for 15 min. The closed reactor is thereupon heated to 55° C. and a solution of 1.79 g V-40 (1,1′-azobis(cyclohexanecarbonitrile), Co. Wako) in 25 ml NMP is injected by means of a syringe via an inlet. The reaction mixture is then agitated for 6 h at 90° C.

The mixture is received in 2 1 NMP after the reaction and precipitated in 5 times the quantity of water. After filtration of the polymer, this is washed with water and ethanol and dried at 60° C. in a vacuum.

The resulting polymer has a relative viscosity of 1.6. The composition corresponded, with 10.1% by mol of methylacrylate and 89.9% by mol of acrylonitrile, almost to the feed values.

The polymer was spun in the spinning tester under the following conditions: temperature zones in the extruder 110° C./ 160° C./ 185° C./200° C.; spinning nozzle temperature 200° C.; maximum draw-off speed of 30 m/min. The titre of the individual fibre was 0.92 tex, the strength 20.3 cN/tex, the breaking elongation 20.9%.

### Example 8

Solution polymerisation to form copolymer with 9% methoxyethylacrylate and 1% dodecylacrylate and also spinning on Mini-Haake

In a 1 1 steel reactor, 222.0 g N-methyl-2-pyrrolidone (NMP), 114.2 g acrylonitrile and 28.0 g 2-methoxyethylacrylate and 5.75 g dodecylacrylate are introduced and made inert with nitrogen by means of an inflow pipe for 15 min. The closed reactor is thereupon heated to 55° C. and a solution of 583 mg V-40 (1,1′-azobis(cyclohexanecarbonitrile), Co. Wako) in 8 ml NMP is injected by means of a syringe via an inlet. The reaction mixture is then agitated for 6 h at 90° C.

The mixture is received in 1 1 NMP after the reaction and precipitated in 5 times the quantity of water. After filtration of the polymer, this is washed with water and ethanol and dried at 60° C. in a vacuum.

The resulting polymer has a relative viscosity of 1.4. The composition corresponded, with 8.8% by mol of methoxyethylacrylate, 1.0% dodecylacrylate and 90.2% by mol of acrylonitrile, almost to the feed values.

The rheological measurement in oscillation mode (temperature sweep) is illustrated in FIG. 9.

No increase in the complex viscosity at temperatures above 230° C. can be noted.

The polymer was spun to form a monofilament in the Mini-Haake at 200° C. with a maximum draw-off speed of 400 m/min. The titre of the fibre was 3.8 tex, the strength 7.5 cN/tex, the breaking elongation 107.5%.

### Example 9

Solution polymerisation to form copolymer with 8% methoxyethylacrylate and 2% dodecylacrylate and also spinning on Mini-Haake In a 1 1 steel reactor, 222.0 g N-methyl-2-pyrrolidone (NMP), 112.2 g acrylonitrile and 24.5 g 2-methoxyethylacrylate and 11.3 g dodecylacrylate are introduced and made inert with nitrogen by means of an inflow pipe for 15 min. The closed reactor is thereupon heated to 55° C. and a solution of 575 mg V-40 (1,1′-azobis(cyclohexanecarbonitrile), Co. Wako) in 8 ml

NMP is injected by means of a syringe via an inlet. The reaction mixture is then agitated for 6 h at 90° C.

The mixture is received in 1 1 NMP after the reaction and precipitated in 5 times the quantity of water. After filtration of the polymer, this is washed with water and ethanol and dried at 60° C. in a vacuum.

The resulting polymer has a relative viscosity of 1.4. The composition corresponded, with 7.9% by mol of methoxyethylacrylate, 1.9% dodecylacrylate and 90.2% by mol of acrylonitrile, almost to the feed values.

The rheological measurement in oscillation mode (temperature sweep) is illustrated in FIG. 9.

No increase in the complex viscosity at temperatures above 230° C. can be noted.

The polymer was spun to form a monofilament in the Mini-Haake at 200° C. with a maximum draw-off speed of 400 m/min. The titre of the fibre was 2.5 tex, the strength 9.1 cN/tex, the breaking elongation 76.2%.

### Example 10

Solution polymerisation to form copolymer with 7% methoxyethylacrylate and 3% dodecylacrylate and also spinning on Mini-Haake

In a 1 1 steel reactor, 222.0 g N-methyl-2-pyrrolidone (NMP), 110.3 g acrylonitrile and 21.0 g 2-methoxyethylacrylate and 16.6 g dodecylacrylate are introduced and made inert with nitrogen by means of an inflow pipe for 15 min. The closed reactor is thereupon heated to 55° C. and a solution of 565 mg V-40 (1,1′-azobis(cyclohexanecarbonitrile), Co. Wako) in 8 ml NMP is injected by means of a syringe via an inlet. The reaction mixture is then agitated for 6 h at 90° C.

The mixture is received in 1 1 NMP after the reaction and precipitated in 5 times the quantity of water. After filtration of the polymer, this is washed with water and ethanol and dried at 60° C. in a vacuum.

The resulting polymer has a relative viscosity of 1.4. The composition corresponded, with 6.8% by mol of methoxyethylacrylate, 3.0% dodecylacrylate and 90.2% by mol of acrylonitrile, almost to the feed values.

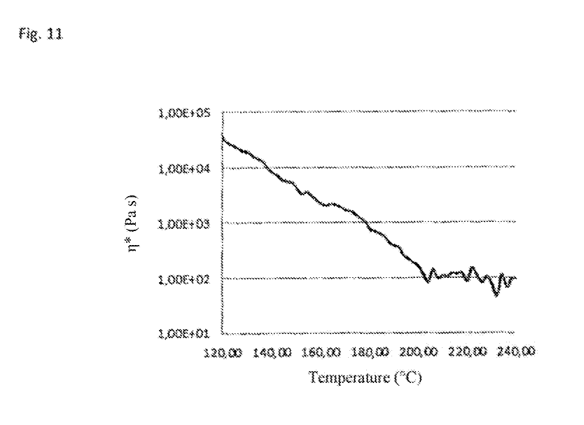

The rheological measurement in oscillation mode (temperature sweep) is illustrated in FIG. 10.

No increase in the complex viscosity at temperatures above 230° C. can be noted.

The polymer was spun to form a monofilament in the Mini-Haake at 200° C. with a maximum draw-off speed of 400 m/min. The titre of the fibre was 2.3 tex, the strength 10.7 cN/tex, the breaking elongation 29.7%.

### Example 11

Solution polymerisation to form copolymer with 5% methoxyethylacrylate and 5% methylacrylate and also spinning on Mini-Haake

In a 100 ml round flask with reflux cooler and nitrogen inflow, 36 g N-methylpyrrolidone are introduced under magnetic agitation. A mixture of 1.8 g methylacrylate, 2.7 g methoxyethylacrylate and 19.6 g acrylonitrile is added and heated with an oil bath to 60° C. A solution of 90 mg V-65 (2,2′azobis(2,4-dimethylvaleronitrile), Co. Wako) in 1 ml acetone is added after reaching the temperature. The reaction time is 6 h. The reaction mixture is precipitated in water, the polymer is filtered off, washed with ethanol and dried in a vacuum.

The resulting polymer has a relative viscosity of 1.5. The molar mass Mw was determined at 47,000 g/mol with a PDI of 1.1. The composition corresponded, with 5.3% by mol of methoxyethylacrylate, 4.5% by mol of methylacrylate and 90.2% by mol of acrylonitrile, almost to the feed values.

The rheological measurement in oscillation mode (temperature sweep) is illustrated in FIG. 11.

No increase in the complex viscosity at temperatures above 230° C. can be noted.

The polymer was spun to form a monofilament in the Mini-Haake at 190° C. with a maximum draw-off speed of 98 m/min. The titre of the fibre was 2.4 tex, the strength 15.0 cN/tex, the breaking elongation 13.8%.

1-16. (canceled)

17. A melt spinnable copolymer of polyacrylonitrile (PAN), which is produced by copolymerisation of 95 to 80% by mol of acrylonitrile with at least one comonomer selected from
a) 5 to 20% by mol of at least one alkoxyalkylacrylate of general formula I 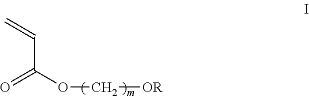
with
R=CₙH₂ₙ₊₁ and n=1-8 and m=1-8,
b) 0 to 10% by mol of at least one alkylacrylate of general formula II 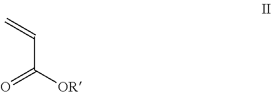
with
R=CₙH₂ₙ₊₁ and n=1-18,
c) 0 to 10% by mol of at least one vinyl ester of general formula III 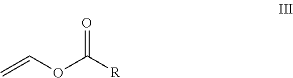
with
R=CₙH₂ₙ₊₁ and n=1-18,
the copolymer having a weight-average molar mass (Mw) in the range of 10,000 to 150,000 g/mol.

18. The copolymer according to claim 17, wherein the copolymer is spinnable at a temperature range from 160 to 240° C.

19. The copolymer according to claim 17, wherein the copolymer has a melt viscosity which is constant or decreasing with increasing temperature up to 240° C.

20. The copolymer according to claim 17, wherein the copolymerisation is effected by precipitation polymerisation in an aqueous medium, emulsion polymerisation in an aqueous medium and/or polymerisation in a solvent.

21. The copolymer according to claim 20, wherein the solvent is selected from the group consisting of dimethylsulphoxide, dimethylformamide, dimethylacetamide, N-methylpyrrolidone, ethylene carbonate, propylene carbonate, aqueous sodium rhodanide solution and mixtures thereof.

22. The copolymer according to claim 17, wherein 8 to 12% by mol of the comonomer is present in a).

23. The copolymer according to claim 17, wherein 1 to 5% by mol of the comonomer is present in b).

24. The copolymer according to claim 17, wherein 1 to 5% by mol of the comonomer is present in c).

25. The copolymer according to claim 17, wherein the copolymer has a weight-average molar mass (Mw) in the range from 15,000 to 80,000 g/mol.

26. A method for the production of fibres or fibre precursors by melt spinning, in which
i. a copolymerisation of 95 to 80% by mol of acrylonitrile with at least one comonomer selected from
a) 5 to 20% by mol of at least one alkoxyalkylacrylate of general formula I 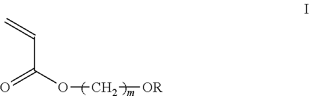
with
R=CₙH₂ₙ₊₁ and n=1-8 and m=1-8,
b) 0 to 10% by mol of at least one alkylacrylate of general formula II 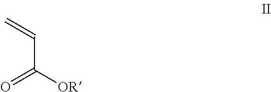
with
R=CₙH₂ₙ₊₁ and n=1-18,
c) 0 to 10% by mol of at least one vinyl ester of general formula III 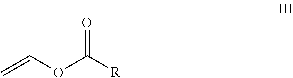
with
R=CₙH₂ₙ₊₁ and n=1-18,
is carried out in the presence of at least one initiator, and
ii. the copolymer is spun from an extruder with at least one nozzle, suitable for spinning, at the extruder outlet, to form mono- or multifilaments.

27. The method according to claim 26, wherein, directly before or during extrusion in b), at least one softening agent is added, which is selected from the group consisting of water, nitroalkanes, alkylalcohols, ionic liquids, glycols, dimethyl sulphoxide, dimethylformamide, dimethylacetamide, N-methylpyrrolidone, ethylene carbonate, propylene carbonate, aqueous sodium rhodanide solution, and mixtures thereof.

28. The method according to claim 26, wherein the fibres are carbon fibres, and the method further includes:
iii. stabilisation of the filaments by a temperature treatment at a temperature from 200 to 350° C. and
iv. carbonisation of the filaments at a temperature from 800 to 1,200° C.

29. The method according to claim 28, wherein stabilisation of the filaments is effected at a temperature from 180 to 320° C.

30. The method according to claim 26, wherein the initiator is selected from the group consisting of azo compounds, peroxides, hydroperoxides, alkylperoxides, peroxodicarbonates, peroxyesters, dialkylperoxides, persulphates, perphosphates, redox initiators, and mixtures thereof.

31. A fibre produced by spinning the copolymer according to claim 17.

32. The fibre according to claim 31, wherein the fibre is a carbon fibre.
